(19) United States
(12) Patent Application Publication
(10) Pub. No.: US 2026/0112702 A1
(43) Pub. Date: Apr. 23, 2026

(54) BATTERY

(71) Applicant: GUANGZHOU TINCI MATERIALS TECHNOLOGY CO., LTD., Guangzhou (CN)

(72) Inventors: Bo LIAO, Guangzhou (CN); Wenpo SUN, Guangzhou (CN); Tian XIE, Guangzhou (CN)

(21) Appl. No.: 19/426,105

(22) Filed: Dec. 19, 2025

Related U.S. Application Data
(63) Continuation of application No. PCT/CN2025/070213, filed on Jan. 2, 2025.

(30) Foreign Application Priority Data
May 31, 2024 (CN) 202410696074.7

(51) Int. Cl. H01M 10/0567; H01M 4/02; H01M 4/131; H01M 4/133; H01M 4/134; H01M 4/136; H01M 4/38; H01M 4/525; H01M 4/58; H01M 4/583; H01M 10/0568

(52) U.S. Cl. CPC H01M 10/0567; H01M 4/131; H01M 4/133; H01M 4/134; H01M 4/136; H01M 4/386; H01M 4/525; H01M 4/5825; H01M 4/583; H01M 10/0568; H01M 2004/027; H01M 2004/028

(57) ABSTRACT

Provided is an electrolyte solution including a compound represented by Formula 1,

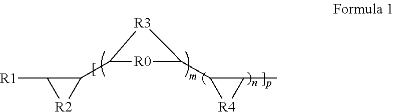

where m and n are integers ranging from 0 to 3, which are not 0 simultaneously; p is an integer ranging from 1 to 5; R₀ is single bond or methylene; R₁ is hydrogen, halogen, hydrocarbyl with 1 to 5 carbon atoms or halogenated hydrocarbyl with 1 to 5 carbon atoms; and R₂, R₃, and R₄ are each independently

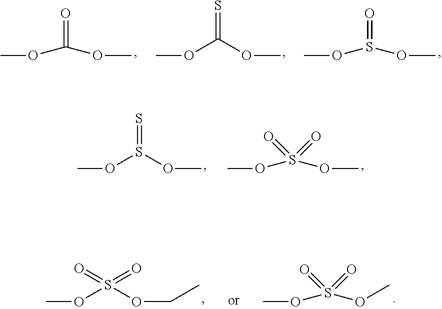

A mass percentage of a transition metal in a negative electrode active material is M; a specific surface area of the negative electrode active material is B m²/g; a ratio of a total mass of the electrolyte solution to a discharge capacity of the battery is N g/Ah; and a mass percentage of the compound represented by Formula 1 in the electrolyte solution is C1, satisfying:

$$0.3 \leq \frac{B * \sqrt[3]{M}}{N * C 1} \leq 5.6 .$$

### CROSS-REFERENCE TO RELATED APPLICATIONS

This application is a continuation of International Application No. PCT/CN2025/070213, filed on Jan. 2, 2025, which claims priority to Chinese Patent Application No. 202410696074.7, filed with China National Intellectual Property Administration on May 31, 2024, and titled “BATTERY”. The disclosures of the aforementioned applications are incorporated herein by reference in their entireties.

### FIELD

The present disclosure relates to the technical field of battery technologies, and more particularly, to a battery.

### BACKGROUND

Resource shortage, energy crisis, and environmental pollution are severe challenges faced by human during production at present. Searching for renewable and resource-saving secondary energy is one of the urgent tasks to be solved for sustainable development of human society. Batteries have unique advantages such as high specific energy, a high operating voltage, a wide application temperature range, a low self-discharge rate, a long cycle life, and good safety performance. Batteries are widely used as power sources in household appliances such as mobile phones, portable computers, video cameras, cameras, etc, and are gradually applied in fields like aviation, aerospace, marine, artificial satellites, small medical devices, and military communication devices. However, with the increasing demand for longer battery life and lighter weight, how to further balance and improve comprehensive performance of batteries (such as low-temperature discharge performance, high-temperature cycle performance, etc.) has become an urgent problem to be solved.

### SUMMARY

In a first aspect, the present disclosure provides a battery. The battery includes a positive electrode plate, a negative electrode plate, and an electrolyte solution. The electrolyte solution includes a compound represented by Formula 1,

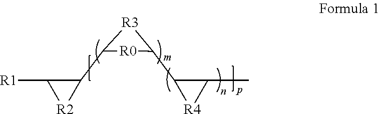

where m is an integer ranging from 0 to 3; n is an integer ranging from 0 to 3; m and n are not 0 simultaneously; p is an integer ranging from 1 to 5; R₀ is single bond or methylene; R₁ is hydrogen, halogen, hydrocarbyl with 1 to 5 carbon atoms or halogenated hydrocarbyl with to 5 carbon atoms; and R₂, R₃, and R₄ are each independently

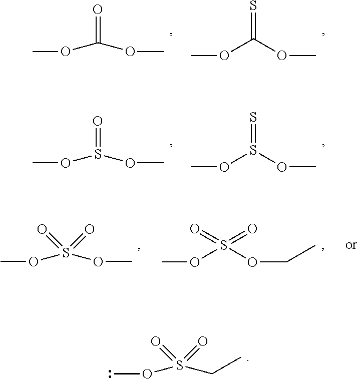

A mass percentage of a transition metal in a negative electrode active material of the negative electrode plate is M. A specific surface area of the negative electrode active material is B m²/g. A ratio of a total mass of the electrolyte solution to a discharge capacity of the battery is N g/Ah. A mass percentage of the compound represented by Formula 1 in the electrolyte solution is C1. These parameters satisfy the following relationship:

$$0.3 \leq \frac{B * \sqrt[3]{M}}{N * C 1} \leq 5.6 .$$

In some embodiments, R₁ is hydrogen, halogen, methyl, ethyl, n-propyl, isopropyl, butyl, pentyl, hexyl, halogenated methyl, halogenated ethyl, halogenated n-propyl, halogenated isopropyl, halogenated butyl, halogenated pentyl, or halogenated hexyl.

In some embodiments, the compound represented by Formula 1 includes at least one of the following compounds:

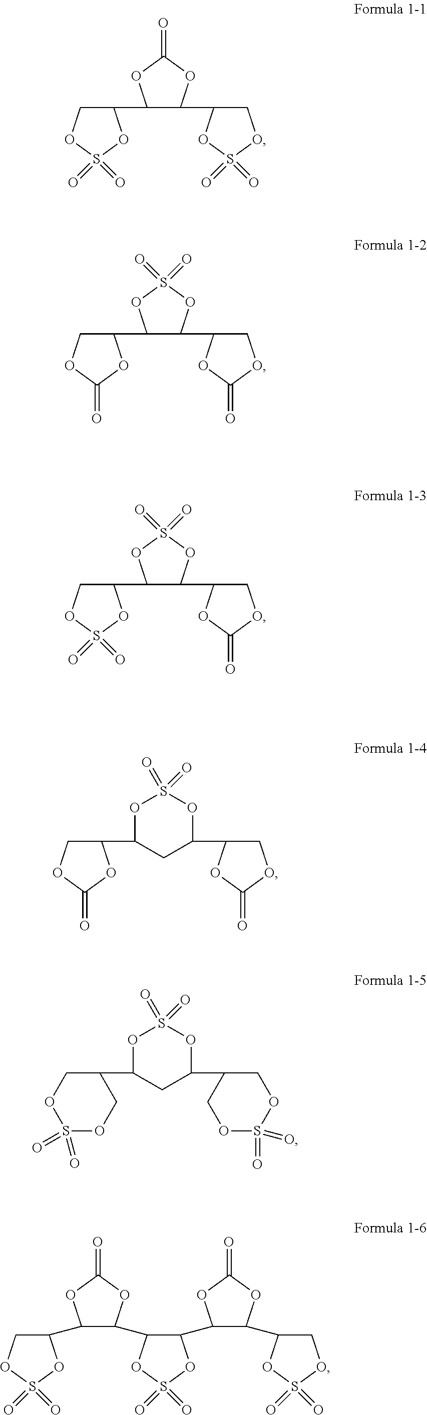 [SMILES: O=C1OC(C2COS(=O)(=O)O2)C(C2COS(=O)(=O)O2)O1 ; O=C1OCC(C2OS(=O)(=O)OC2C2COC(=O)O2)O1 ; O=C1OCC(C2OS(=O)(=O)OC2C2COS(=O)(=O)O2)O1 ; O=C1OCC(C2CC(C3COC(=O)O3)OS(=O)(=O)O2)O1 ; O=S1(=O)OCC(C2CC(C3COS(=O)(=O)OC3)OS(=O)(=O)O2)CO1 ; O=C1OC(C2COS(=O)(=O)O2)C(C2OS(=O)(=O)OC2C2OC(=O)OC2C2COS(=O)(=O)O2)O1]

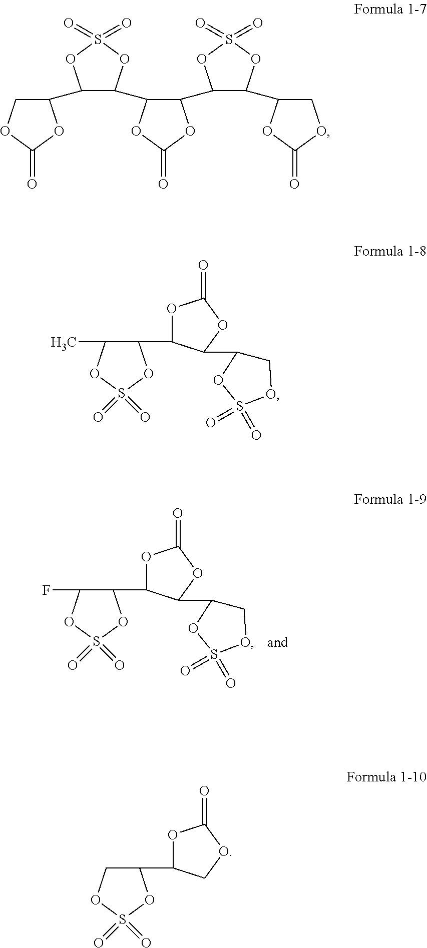 [SMILES: O=C1OCC(C2OS(=O)(=O)OC2C2OC(=O)OC2C2OS(=O)(=O)OC2C2COC(=O)O2)O1 ; CC1OS(=O)(=O)OC1C1OC(=O)OC1C1COS(=O)(=O)O1 ; O=C1OC(C2COS(=O)(=O)O2)C(C2OS(=O)(=O)OC2F)O1 ; O=C1OCC(C2COS(=O)(=O)O2)O1]

In some embodiments, 0.005%≤M≤0.03%.

In some embodiments, 0.3%≤C1≤4%.

In some embodiments, the transition metal includes at least one of iron, copper, nickel, or zinc.

In some embodiments, 0.7≤B≤2.5.

In some embodiments, 2≤N≤4.5.

In some embodiments, the negative electrode active material of the negative electrode plate includes a graphite or a silicon-based material.

In some embodiments, the electrolyte solution further includes an electrolyte salt, the electrolyte salt including lithium salt or sodium salt.

In some embodiments, based on the total mass of the electrolyte solution, a mass percentage of the electrolyte salt ranges from 10% to 20%.

In some embodiments, the battery satisfies one of the following (a) and (b): (a) the battery is a lithium battery, and a positive electrode active material of the positive electrode plate includes a lithium iron phosphate material, a nickel-cobalt-manganese ternary material, a lithium cobalt oxide material, a lithium manganese iron phosphate material, a lithium manganese oxide material or a lithium nickel manganese oxide material; and (b) the battery is a sodium battery, and the positive electrode active material of the positive electrode plate includes a sodium iron phosphate material or a three-dimensional tunnel-type Na_{0.44}MnO₂.

### DETAILED DESCRIPTION

Unless otherwise defined, all technical and scientific terms used herein have the same meanings as commonly understood by those skilled in the art to which this disclosure pertains. The terms used herein are intended to describe specific embodiments only, and are not meant to limit the present disclosure. Unless otherwise specified, numerical values of the parameters mentioned in the present disclosure can be measured by various measurement methods commonly used in the art (for example, tests may be performed according to the methods given in the embodiments of the present disclosure).

The terms “comprise”, “include” and “have” and any variations thereof in the specification and claims of the present disclosure are open-ended expressions, that is, including what is specified in the present disclosure, but not excluding other aspects.

In the description of the present disclosure, all numbers disclosed herein are approximations, regardless of whether words “about” or “about” are used. Numerical value of each number may have a variation within 10% or a variation considered reasonable by those skilled in the art, such as a variation of 1%, 2%, 3%, 4%, or 5%.

In an aspect, the present disclosure provides a battery. The battery includes a positive electrode plate, a negative electrode plate, and an electrolyte solution.

The electrolyte solution includes a compound represented by Formula 1,

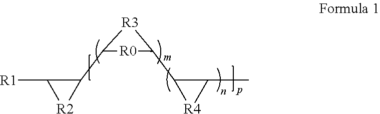

where m is an integer ranging from 0 to 3; n is an integer ranging from 0 to 3; m and n are not 0 simultaneously; p is an integer ranging from 1 to 5; R₀ is single bond or methylene; R₁ is hydrogen, halogen, hydrocarbyl with 1 to 5 carbon atoms or halogenated hydrocarbyl with 1 to 5 carbon atoms; and R₂, R₃, and R₄ are each independently

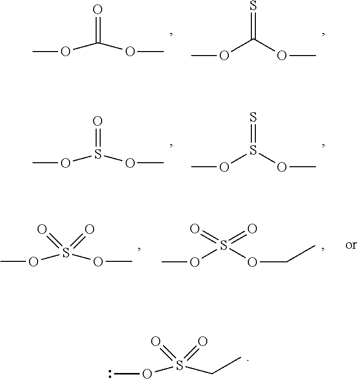

A mass percentage of a transition metal in a negative electrode active material of the negative electrode plate is M. A specific surface area of the negative electrode active material is B m²/g. A ratio of a total mass of the electrolyte solution to a discharge capacity of the battery is N g/Ah. A mass percentage of the compound represented by Formula 1 in the electrolyte solution is C1. These parameters satisfy the following relationship:

$$0.3 \leq \frac{B * \sqrt[3]{M}}{N * C 1} \leq 5.6 .$$

The battery of the present disclosure includes the positive electrode plate, the negative electrode plate, and the electrolyte solution. The electrolyte solution includes the compound represented by Formula 1. Although the compound represented by Formula 1 can form a porous and stable SEI film on a negative electrode surface during first charging and cycling of the battery, which effectively improves kinetic performance of the battery, it was found that how the aforementioned SEI film affects the performance of the battery is closely related to several factors. These factors include: the mass percentage M of the transition metal in the negative electrode active material of the negative electrode plate, the specific surface area B m²/g of the negative electrode active material, the ratio N g/Ah of the total mass of the electrolyte solution to the discharge capacity of the battery, and the mass percentage C1 of the compound represented by Formula 1 in the electrolyte solution. It was found that when the above parameters satisfy the following relationship:

$$0.3 \leq \frac{B * \sqrt[3]{M}}{N * C 1} \leq 5.6 ,$$

the battery exhibits excellent overall performance, particularly outstanding low-temperature discharge performance and cycling stability. This is because N determines the total mass of the electrolyte solution in the battery, which can largely determine the number of molecules of the compound represented by Formula 1 retained in the battery. While B and M greatly affect the consumed number of molecules of the compound of Formula 1 required for formation of the SEI film. When the above relationship is satisfied, the amount of molecules of the compound represented by Formula 1 in the battery is precisely sufficient to form a complete SEI film without excess. Therefore, the battery has excellent low-temperature discharge performance and cycle performance.

In some embodiments of the present disclosure, R₁ is hydrogen, halogen, methyl, ethyl, n-propyl, isopropyl, butyl, pentyl, hexyl, halogenated methyl, halogenated ethyl, halogenated n-propyl, halogenated isopropyl, halogenated butyl, halogenated pentyl, or halogenated hexyl. Therefore, during the first charging and cycling of the battery, the compound represented by Formula 1 can be preferentially reduced over the solvent of the electrolyte solution on a negative electrode surface relative, forming an SEI film that is enriched with sulfonate compounds and low in fluoride salt compounds. The resulting SEI film is porous, facilitating rapid transport of ions during charging and discharging. Consequently, the SEI film exhibits low impedance and high stability, effectively improving the kinetic performance of the battery and enhancing the low-temperature discharge performance and the cycling stability of the battery.

In some embodiments of the present disclosure, the compound represented by Formula 1 includes at least one of the following compounds:

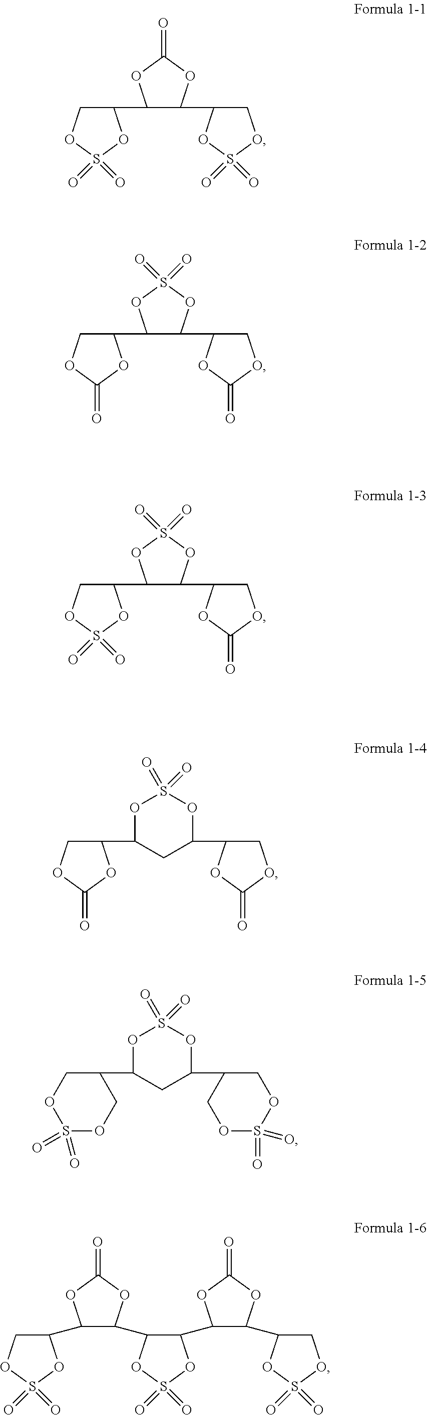 [SMILES: O=C1OC(C2COS(=O)(=O)O2)C(C2COS(=O)(=O)O2)O1 ; O=C1OCC(C2OS(=O)(=O)OC2C2COC(=O)O2)O1 ; O=C1OCC(C2OS(=O)(=O)OC2C2COS(=O)(=O)O2)O1 ; O=C1OCC(C2CC(C3COC(=O)O3)OS(=O)(=O)O2)O1 ; O=S1(=O)OCC(C2CC(C3COS(=O)(=O)OC3)OS(=O)(=O)O2)CO1 ; O=C1OC(C2COS(=O)(=O)O2)C(C2OS(=O)(=O)OC2C2OC(=O)OC2C2COS(=O)(=O)O2)O1]

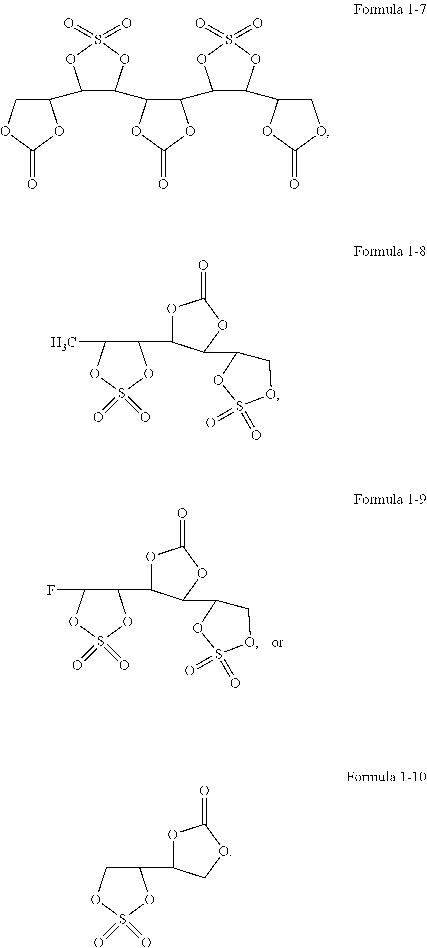 [SMILES: O=C1OCC(C2OS(=O)(=O)OC2C2OC(=O)OC2C2OS(=O)(=O)OC2C2COC(=O)O2)O1 ; CC1OS(=O)(=O)OC1C1OC(=O)OC1C1COS(=O)(=O)O1 ; O=C1OC(C2COS(=O)(=O)O2)C(C2OS(=O)(=O)OC2F)O1 ; O=C1OCC(C2COS(=O)(=O)O2)O1]

Therefore, during the first charging and cycling of the battery, the compound represented by Formula 1 can be preferentially reduced over the solvent of the electrolyte solution on a negative electrode surface relative, forming an SEI film that is enriched with sulfonate compounds and low in fluoride salt compounds. The resulting SEI film is porous, facilitating rapid transport of ions during charging and discharging. Consequently, the SEI film exhibits low impedance and high stability, effectively improving the kinetic performance of the battery and enhancing the low-temperature discharge performance and the cycling stability of the battery.

In some embodiments of the present disclosure, 0.005%≤M≤0.03%. For example, M may be 0.005%, 0.007%, 0.01%, 0.015%, 0.02%, 0.025%, 0.03%, etc. The transition metal in the negative electrode active material exhibits strong electron conductivity. Furthermore, it possesses higher electrochemical activity than negative electrode active material itself, which is prone to catalyzing reduction and decomposition of the compound represented by Formula 1. When the negative electrode active material has a high content of transition metal, a larger number of molecules of the compound represented by Formula 1 is required to form an SEI film that completely covers a negative electrode. As a result, the mass percentage of the transition metal in the negative electrode active material of the negative electrode plate is controlled within the above range, which can form an SEI film having low impedance and high stability, thereby improving the low-temperature discharge performance and the cycling stability of the battery. It should be noted that the transition metal in the negative electrode active material is an impurity metal during preparation of the negative electrode active material. The transition metal can be introduced, for example, through a raw material, equipment wear, or air dust.

As an example, the transition metal includes at least one of iron, copper, nickel, or zinc.

In some embodiments of the present disclosure, 0.3%≤C1≤4%. It was found that when C1 is controlled within the above range, the compound represented by Formula 1 can form a porous and stable SEI film on the negative electrode surface, significantly reducing interface impedance, and effectively improving the kinetic performance of the battery.

In some embodiments of the present disclosure, 0.7≤B≤2.5. For example, B may be 0.7, 0.9, 1.1, 1.3, 1.5, 1.7, 1.9, 2.1, 2.3, 2.5, etc. The surface of the negative electrode active material contains active sites. At these sites, the compound represented by Formula 1 is reduced. An increase of the specific surface area of the negative electrode active material corresponds to an increase in the active sites, thus requiring a greater amount of the compound represented by Formula 1 to form the complete SEI film. By controlling the specific surface area of the negative electrode active material within the above range in the present disclosure, the SEI film with low impedance and high stability can be formed, thereby improving the low-temperature discharge performance and the cycling stability of the battery.

In some embodiments of the present disclosure, the negative electrode plate includes a negative electrode current collector and a negative electrode active material layer disposed on at least one surface of the negative electrode current collector. The negative electrode active material layer includes the negative electrode active material and at least one of a first binder and a first conductive agent.

In some embodiments of the present disclosure, the negative electrode active material may be a negative electrode active material known in the art for use in the battery. As an example, the negative electrode active material may include at least one of the following materials: a graphite, a soft carbon, a hard carbon, a silicon-based material, a tin-based materials, and a lithium titanate, among others. The graphite or the silicon-based material is preferred due to the excellent cycle life thereof, which can enhance cycling performance and a service life of the battery.

As an example, the silicon-based material may include at least one of elemental silicon, a silicon oxygen compound, a silicon-carbon composite, a silicon-nitrogen composite, or a silicon alloy. The tin-based material may include at least one of elemental tin, a tin oxygen compound, or a tin alloy.

In some embodiments of the present disclosure, a metal foil or a composite current collector may be used as the negative electrode current collector. For example, a copper foil can be used as the metal foil. The composite current collector may include a polymer substrate and a metal layer formed on at least one surface of a polymer substrate. The composite current collector may be formed by depositing a metal material (e.g., copper, copper alloy, nickel, nickel alloy, or the like) onto a polymer substrate (such as polypropylene (PP), polyethylene terephthalate (PET), or polybutylene terephthalate (PBT)).

In some embodiments of the present disclosure, the first binder may include at least one of sodium carboxymethyl cellulose (CMC), styrene-butadiene rubber (SBR), polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, polyamide-imide, polyvinyl alcohol, and sodium polyacrylate.

In some embodiments of the present disclosure, the first conductive agent may include at least one of natural graphite, artificial graphite, carbon black, acetylene black, Ketjen black, carbon fiber, and graphene.

In some embodiments of the present disclosure, a mass ratio of the negative electrode active material, the first conductive agent, and the first binder is (90 to 99):(0 to 5):(1 to 10).

In some embodiments of the present disclosure, the positive electrode plate includes a positive electrode current collector and a positive electrode active material layer disposed on at least one surface of the positive electrode current collector. The positive electrode active material layer includes the positive electrode active material and at least one of a second binder and a second conductive agent.

In some embodiments of the present disclosure, the positive electrode current collector may include a metal foil or a composite positive electrode current collector. For example, an aluminum foil may be used as the metal foil. The composite positive electrode current collector may include a polymer substrate and a metal layer formed on at least one surface of the polymer substrate. For example, the composite negative electrode current collector may be formed by depositing a metal material (e.g., aluminum, aluminum alloy, nickel, nickel alloy, etc.) onto the polymer substrate (such as polypropylene (PP), polyethylene terephthalate (PET), or polybutylene terephthalate (PBT)).

As an example, the positive electrode current collector has two surfaces facing each other in a thickness direction of the positive electrode current collector. The positive electrode active material layer is disposed on either or both of the two surfaces facing each other.

As an example, when the battery is a lithium-ion battery, the positive electrode active material may include, but is not limited to, a lithium iron phosphate material, an LiCoO₂ material, an LiNiO₂ material, a nickel-cobalt-manganese ternary material (LiNiₓCo_{y}Mn_{z}O₂, where x+y+z=1, 0<x<1, 0<y<1, 0<z<1), a lithium-rich manganese-based material (nLi₂MnO₃·(1−n)LiMO₂, where 0<n<1, and M is at least one of Ni, Co, or Mn), a lithium nickel manganese oxide (LiNi_{0.5}Mn_{1.5}O₄) material, a lithium manganese iron phosphate material, a lithium manganese oxide material, and a lithium nickel manganese oxide material, among others. The lithium iron phosphate material, the nickel-cobalt-manganese ternary material, the lithium cobalt oxide material, the lithium manganese iron phosphate material, the lithium manganese oxide material, or the lithium nickel manganese oxide material are preferred due to the excellent cycling performance and high energy density thereof, which can enhance the battery's cycling stability.

In some embodiments of the present disclosure, the battery is a lithium battery. The negative electrode active material is a graphite or silicon-based material. The positive electrode active material is the lithium iron phosphate material, the nickel-cobalt-manganese ternary material, the lithium cobalt oxide material, the lithium manganese iron phosphate material, the lithium manganese oxide material, or the lithium nickel manganese oxide material. The compound represented by Formula 1 in conjunction with the negative electrode active material and the positive electrode active material can significantly improve the kinetic performance of the battery, and satisfy the following relationship:

$$0.3 \leq \frac{B * \sqrt[3]{M}}{N * C 1} \leq 5.6 .$$

In this way, the battery has excellent comprehensive performance, thereby improving the low-temperature discharge performance and cycling performance of the battery.

As an example, when the battery is a sodium-ion battery, the positive electrode active material includes, but is not limited to, a three-dimensional tunnel-type Na_{0.44}MnO₂, a P2 layered NaMO₂ (where M is at least one of Ni, Mn, and Fe), NaFePO₄, Na₄Fe₃(PO₄)₂P₂O₇, Na₃V₂(PO₄)₃, Na₃V₂(PO₄)₂F₃, Na₂Fe(CN)₆, and Na₂MnFe(CN)₆. Preferred material includes a sodium iron phosphate material or the three-dimensional tunnel-type Na_{0.44}MnO₂, which exhibits excellent cycling performance and high energy density, thereby enhancing the cycling stability of the battery.

In some embodiments of the present disclosure, the battery is a sodium battery. The negative electrode active material is the graphite or the silicon-based material. The positive electrode active material is the sodium iron phosphate material or the three-dimensional tunnel-type Na_{0.44}MnO₂. The compound represented by Formula 1 in conjunction with the above negative electrode active material and the positive electrode active material can significantly improve the kinetic performance of the battery, and satisfy the following formula:

$$0.3 \leq \frac{B * \sqrt[3]{M}}{N * C 1} \leq 5.6 .$$

In this way, the battery has excellent comprehensive performance, thereby improving the low-temperature discharge performance and the cycling performance of the battery.

In some embodiments of the present disclosure, the second conductive agent includes at least one of carbon black, acetylene black, graphene, Ketjen black, or carbon fiber.

In some embodiments of the present disclosure, the second binder includes at least one of polytetrafluoroethylene, polyvinylidene fluoride (PVDF), polyvinyl fluoride, polyethylene, polypropylene, polyvinyl alcohol, carboxymethyl cellulose, hydroxypropyl cellulose, diacetyl cellulose, polyvinyl chloride, carboxylated polyvinyl chloride, ethylene oxide-containing polymers, polyvinylpyrrolidone, or polyurethane.

In some embodiments of the present disclosure, a mass ratio of the positive electrode active material, the second conductive agent, and the second binder is (90 to 99.5):(0.25 to 5):(0.25 to 5).

In some embodiments of the present disclosure, 2≤N≤4.5. For example, N may be 2, 2.3, 2.5, 2.7, 3, 3.2, 3.5, 4, or 4.5. Herein, N represents an actual amount of the compound represented by Formula 1 held in the battery. By controlling the ratio N of the total mass of the electrolyte solution to the discharge capacity of the battery within the above range, the electrolyte solution can effectively infiltrate gaps in the positive electrode plate and the negative electrode plate, while also helps to control the gap between the positive electrode and the negative electrode to reduce internal resistance. In this way, the low-temperature discharge performance and the cycling stability performance of the battery can be improved. It should be noted that the discharge capacity of the battery according to the present disclosure is determined by charging the battery to full capacity at a current rate of 0.5C, followed by discharging at the same current rate of 0.5C, and measuring the obtained capacity.

In some embodiments of the present disclosure, the electrolyte solution further includes an electrolyte salt. The electrolyte salt includes a lithium salt or a sodium salt.

As an example, the lithium salt includes at least one of lithium hexafluorophosphate (LiPF₆), lithium bis(fluorosulfonyl)imide (LiFSI), or lithium bis(trifluoromethanesulfonyl)imide (LiTFSI).

As an example, the sodium salt includes at least one of sodium hexafluorophosphate, sodium tetrafluoroborate, sodium bis(fluorosulfonyl)imide (NaFSI), sodium bis(trifluoromethylsulfonyl)imide, sodium bis(oxalato)borate, sodium difluorobis(oxalato)borate, sodium difluorobis(oxalato)phosphate, sodium tetrafluoro(oxalato)phosphate, or sodium 4,5-dicyano-2-trifluoromethylimidazole.

In some embodiments of the present disclosure, the electrolyte solution further includes a solvent. The solvent includes at least one of carbonates (e.g., cyclic carbonates and liner carbonates), carboxylic esters (e.g., cyclic carboxylic esters and liner carboxylic esters), ether compounds (e.g., cyclic ether compounds and liner ether compounds), phosphorus-containing compounds, sulfur-containing compounds, or aromatic fluorine-containing compounds.

As an example, the solvent includes at least one of ethylene carbonate (EC), propylene carbonate (PC), diethyl carbonate (DEC), dimethyl carbonate (DMC), ethyl methyl carbonate (EMC), fluoroethylene carbonate (FEC), propyl butyrate (PB), ethyl butyrate (EB), propyl propionate (PP), ethyl propionate (EP), methyl propionate (MP), propyl acetate (PA), ethyl acetate (EA), methyl acetate (MA), propyl formate (PF), ethyl formate (EF), methyl formate (MF), or γ-butyrolactone.

In some embodiments of the present disclosure, based on the total mass of the electrolyte solution, a mass percentage of the electrolyte salt ranges from 10% to 20%. For example, the mass percentage of electrolyte salt may be 10%, 11%, 12%, 13%, 14%, 15%, 16%, 17%, 18%, 19%, 20%, etc. Controlling the mass percentage of the electrolyte salt in the electrolyte solution within the above range can ensure that the battery has stable electrochemical properties.

In some embodiments of the present disclosure, the battery further includes a separator. The separator includes, but is not limited to, glass fiber, non-woven fabric, polyethylene, polypropylene, or polyvinylidene fluoride.

Hereinafter, the embodiments of the present disclosure are described with reference to specific examples. It should be noted that the following examples are merely used to illustrate the present disclosure, and should not be regarded as limiting the scope of the present disclosure. Where no specific techniques or conditions are specified in the examples, the techniques or conditions commonly known and described in the relevant literature in the art or as specified in the product specification shall be applied. Unless otherwise indicated, all reagents and instruments used were conventional products available from commercial sources.

### Example 1

### (1) Preparation of Compound of Formula 1-1

500 g of dimethyl sulfoxide and 50 g of ethylene carbonate were added to a three-necked flask containing 108.1 g of mannitol. Then, 2 g of pyridine was added as a catalyst. The mixture was heated to 70° C. under a reduced pressure of 500 Pa with continuous stirring for 6 hours. Subsequently, 115.9 g of sulfonyl fluoride was added, and the reaction continued under a reduced pressure of 500 Pa with stirring for another 6 hours. After that, heating was stopped and the resultant was cooled down to room temperature. Recrystallization was carried out by adding 500 g of ethyl methyl ether, followed by vacuum filtration to obtain a white solid product (the compound of Formula 1-1).

(2) Preparation of the electrolyte solution: under an inert atmosphere (moisture<0.1 ppm, oxygen<1 ppm), ethylene carbonate (EC), ethyl methyl carbonate (EMC), and ethyl acetoacetate (EA) were thoroughly mixed in a mass ratio of EC:EMC:EA=3:3:4. Lithium bis(fluorosulfonyl)imide (LiFSI) and lithium hexafluorophosphate (LiPF₆) were then added. A mass percentage of LiFSI in the electrolyte solution was 2 wt %, and a mass percentage of LiPF₆ in the electrolyte solution was 10 wt %. The compound of Formula 1-1 was then added, and a mass ratio C1 of the compound of Formula 1-1 was 0.6 wt % based on the total mass of the electrolyte solution.

(3) Preparation of the positive electrode plate: the positive electrode active material (lithium iron phosphate), the conductive agent (acetylene black), and the binder (poly(vinylidene fluoride)) were dispersed in an N-methylpyrrolidone (NMP) solvent at a mass ratio of 96:2:2. The mixture was thoroughly stirred to form a uniform positive electrode slurry (with a solid content of 60 wt %). The slurry was coated evenly onto an aluminum foil of the positive electrode current collector, followed by drying, rolling, and slitting to obtain the positive electrode plate.

(4) Preparation of the negative electrode plate: the negative electrode active material (the graphite), the conductive agent (acetylene black), the binder (sodium carboxymethyl cellulose), and styrene-butadiene rubber (SBR) were dispersed in an appropriate amount of deionized water at a mass ratio of 95:2:2:1. The mixture was thoroughly stirred to form a uniform negative electrode slurry (with a solid content of 50 wt %). The slurry was then evenly coated onto a copper foil of the negative electrode current collector, followed by drying, rolling, and slitting to obtain the negative electrode plate. The transition metal content M in the graphite was 0.01 wt %, with iron as the transition metal. The specific surface area of the graphite was 1.2 m²/g. The test methods for a transition metal content and the specific surface area of the graphite are specified in the standard GB/T 24533-2019.

(5) Preparation of the Battery: the positive electrode plate, the separator, and the negative electrode plate were stacked in sequence such that the separator was located between the positive electrode plate and the negative electrode plate to provide isolation. The assembly was then wound to form a bare cell core, which was placed into an outer packaging shell. After drying, 8 g of the electrolyte solution prepared in step (2) was injected into the packaging shell. The battery was completed through a series of processes including vacuum sealing, standing, formation, and shaping. A rated capacity of the battery was 2 Ah. The ratio N g/Ah of the total mass of the electrolyte solution to the discharge capacity of the battery was 4 g/Ah. Specifically, the battery exhibits a capacity of 2 Ah when charged and discharged at a current of 0.5 C and

$$\frac{B * \sqrt[3]{M}}{N * C 1} = 2.32 .$$

### Example 2

Example 2 differs from Example 1 in that the compound of Formula 1-2 was prepared instead of the compound of Formula 1-1. Specifically, the preparation process of the compound of Formula 1-2 differs from that of the compound of Formula 1-1 in that the amounts of dimethyl carbonate and sulfonyl fluoride added were 100 g and 57.95 g, respectively.

### Example 3

Example 3 differs from Example 1 in that the compound of Formula 1-3 was prepared instead of the compound of Formula 1-1. Specifically, the preparation process of the compound of Formula 1-3 differed from that of the compound of Formula 1-1 in terms of both amounts and orders of material addition. The specific preparation process was as follows: 500 g of dimethyl sulfoxide and 57.95 g of sulfonyl fluoride were added to a reaction kettle containing 108.1 g of mannitol, followed by addition of 2 g of pyridine as a catalyst. The mixture was heated to 70° C. under a pressure of 500 Pa and stirred continuously for 6 hours. Then, 50 g of dimethyl carbonate and 57.95 g of sulfonyl fluoride were added, and the reaction was continued under a pressure of 500 Pa with stirring for another 6 hours. After the heating was stopped, the resultant was cooled down to the room temperature. Finally, 500 g of methyl ethyl ether was added to perform recrystallization, and the resulting solid was collected by vacuum filtration to obtain the white solid (the compound of Formula 1-3).

### Example 4

Example 4 differs from Example 1 in that the compound of Formula 1-4 was prepared instead of the compound of Formula 1-1. The preparation process of the compound of Formula 1-4 differed from that of the compound of Formula 1-2 in that heptane-1,2,3,5,6,7-hexaol was used instead of mannitol.

### Example 5

Example 5 differs from Example 1 in that the compound of Formula 1-5 was prepared instead of the compound of Formula 1-1. Specifically, the preparation process of the compound of Formula 1-5 differed from that of the compound of Formula 1-2 in that 2,6-dimethoxyheptane-1,3,7-triol was used instead of mannitol and that the 100 g of dimethyl carbonate was replaced with 115.9 g of sulfonyl fluoride.

### Example 6

Example 6 differs from Example 1 in that the compound of Formula 1-6 was prepared instead of the compound of Formula 1-1. Specifically, the preparation process of the compound of Formula 1-6 differed from that of the compound of Formula 1-1 in that mannitol was replaced with decane-1,2,3,4,5,6,7,8,9,10-decaol and that the amounts of dimethyl carbonate and sulfonyl fluoride added were 100 g and 173.85 g, respectively.

### Example 7

Example 7 differs from Example 1 in that the compound of Formula 1-7 was prepared instead of the compound of Formula 1-1. The preparation process of the compound of Formula 1-7 differed from that of the compound of Formula 1-6 in that the amounts of dimethyl carbonate and sulfonyl fluoride added were 150 g and 115.9 g, respectively.

### Example 8

Example 8 differs from Example 1 in that the compound of Formula 1-8 was prepared instead of the compound of Formula 1-1. Specifically, the preparation process of the compound of Formula 1-8 differed from that of the compound of Formula 1-1 in that the mannitol was replaced with heptane-1,2,3,4,5,6-hexaol.

### Example 9

Example 9 differs from Example 1 in that the compound of Formula 1-9 was prepared instead of the compound of Formula 1-1. Specifically, the preparation process of the compound of Formula 1-9 differed from that of the compound of Formula 1-1 in that the mannitol was replaced with 1-fluorohexane-1,2,3,4,5,6-hexaol.

### Example 10

Example 10 differs from Example 1 in that the compound of Formula 1-10 was prepared instead of the compound of Formula 1-1. Specifically, the preparation process of the compound of Formula 1-10 differed from that of the compound of Formula 1-1 in that the mannitol was replaced with erythritol and that the amount of sulfonyl fluoride added was adjusted to 57.95 g.

### Example 11

Example 11 differs from Example 1 in that the transition metal content M was adjusted to 0.005 wt % and thus N*C1=1.84.

$$\frac{B * \sqrt[3]{M}}{N * C 1} = 1.84 .$$

### Example 12

Example 12 differs from Example 1 in that the transition metal content M was adjusted to 0.03 wt % and thus

$$\frac{B * \sqrt[3]{M}}{N * C 1} = 3.35 .$$

### Example 13

Example 13 differs from Example 1 in that the specific surface area of the graphite was adjusted to 0.7 g/cm³ and thus

$$\frac{B * \sqrt[3]{M}}{N * C 1} = 1.35 .$$

### Example 14

Example 14 differs from Example 1 in that the specific surface area of the graphite was adjusted to 2.5 g/cm³ and thus

$$\frac{B * \sqrt[3]{M}}{N * C 1} = 4.83 .$$

### Example 15

Example 15 differs from Example 1 in that, in step (2), the mass ratio C1 of the compound of Formula 1-1, based on the total mass of the electrolyte solution, was adjusted to 0.3 wt % and thus

$$\frac{B * \sqrt[3]{M}}{N * C 1} = 4.64 .$$

### Example 16

Example 16 differs from Example 1 in that, in step (2), the mass ratio C1 of the compound of Formula 1-1, based on the total mass of the electrolyte, was adjusted to 4.0 wt % and thus

$$\frac{B * \sqrt[3]{M}}{N * C 1} = 0.35 .$$

### Example 17

Example 17 differs from Example 1 in that, in step (4), the specific surface area of the graphite was adjusted to 2.7 g/cm³ and thus

$$\frac{{B}^{3} * \sqrt[3]{M}}{N * C 1} = 5.22 .$$

### Example 18

Example 18 differs from Example 1 in that, in step (4), the specific surface area of the graphite was adjusted to 0.6 g/cm³ and thus

$$\frac{B * \sqrt[3]{M}}{N * C 1} = 1.16 .$$

### Example 19

Example 19 differs from Example 1 in that the total mass of the electrolyte solution was adjusted to 10 g, the discharge capacity of the battery was 2 Ah, and thus the ratio of the total mass of the electrolyte solution to the discharge capacity of the battery was 5 g/Ah and

$$\frac{B * \sqrt[3]{M}}{N * C 1} = 1.86 .$$

### Example 20

Example 20 differs from Example 1 in that the total mass of the electrolyte solution was adjusted to 3.6 g, the discharge capacity of the battery was 2 Ah, and thus the ratio of the total mass of the electrolyte solution to the discharge capacity of the battery was 1.8 g/Ah and

$$\frac{B * \sqrt[3]{M}}{N * C 1} = 5.16 .$$

### Example 21

Example 21 differs from Example 1 in that the transition metal content M was adjusted to 0.05 wt % and thus

$$\frac{B * \sqrt[3]{M}}{N * C 1} = 3.97 .$$

### Example 22

Example 22 differs from Example 1 in that the transition metal content M was adjusted to 0.004 wt % and thus

$$\frac{B * \sqrt[3]{M}}{N * C 1} = 1.71 .$$

### Example 23

Example 23 differs from Example 1 in that, based on the total mass of the electrolyte solution, the mass percentage of the compound of Formula 1-1 was adjusted to 4.5 wt % and thus

$$\frac{B * \sqrt[3]{M}}{N * C 1} = 0.31 .$$

### Example 24

Example 24 differs from Example 1 in that, based on the total mass of the electrolyte solution, the mass percentage of the compound of Formula 1-1 was adjusted to 0.25 wt % and thus

$$\frac{B * \sqrt[3]{M}}{N * C 1} = 5.57 .$$

### Example 25

Example 25 differs from Example 1 in that the total mass of the electrolyte solution was adjusted to 4 g, the discharge capacity of the battery was 2 Ah, and thus the ratio of the total mass of the electrolyte solution to the discharge capacity of the battery was 2 g/Ah and

$$\frac{B * \sqrt[3]{M}}{N * C 1} = 4.64 .$$

### Example 26

Example 26 differs from Example 1 in that the total mass of the electrolyte solution was adjusted to 9 g, the discharge capacity of the battery was 2 Ah, and thus the ratio of the total mass of the electrolyte solution to the discharge capacity of the battery was 4.5 g/Ah and

$$\frac{B * \sqrt[3]{M}}{N * C 1} = 2.06 .$$

### Example 27

Example 27 differs from Example 1 in that 1 wt % 1,3-propanesultone (PS), based on the total mass of the electrolyte solution, was added to the electrolyte solution and thus

$$\frac{B * \sqrt[3]{M}}{N * C 1} = 2.32 .$$

### Example 28

Example 28 differs from Example 1 in that the positive electrode active material was adjusted to LiNi_{0.5}Co_{0.2}Mn_{0.3}O₂ and thus

$$\frac{B * \sqrt[3]{M}}{N * C 1} = 2.32 .$$

### Example 29

Example 29 differs from Example 1 in that a sodium battery was prepared instead of a lithium battery. Specifically, the electrolyte solution included sodium bis(fluorosulfonyl)imide (NaFSI) and sodium hexafluorophosphate (NaPF₆), and the positive electrode active material was NaFePO₄. A mass percentage of NaFSI in the electrolyte solution was 2 wt %, a mass percentage of NaPF₆ in the electrolyte solution was 10 wt %, and thus

$$\frac{B * \sqrt[3]{M}}{N * C 1} = 2.32 .$$

### Comparative Example 1

Comparative Example 1 differs from Example 1 in that the compound of Formula 1-1 was not added to the electrolyte solution.

### Comparative Example 2

Comparative Example 2 differs from Example 28 in that the compound of Formula 1-1 was not added to the electrolyte solution.

### Comparative Example 3

Comparative Example 3 differs from Example 1 in that, based on the total mass of the electrolyte solution, the mass percentage of the compound of Formula 1-1 was adjusted to 0.3 wt %, the specific surface area of the graphite was adjusted to 2.5 g/cm³ and thus

$$\frac{B * \sqrt[3]{M}}{N * C 1} = 9.67 .$$

### Comparative Example 4

Comparative Example 4 differs from Example 1 in that, based on the total mass of the electrolyte solution, the mass percentage of the compound of Formula 1-1 was adjusted to 4.0 wt %, the transition metal content M in the graphite was adjusted to 0.005 wt % and thus

$$\frac{B * \sqrt[3]{M}}{N * C 1} = 0.28 .$$

### Comparative Example 5

Comparative Example 5 differs from Example 1 in that, based on the total mass of the electrolyte solution, the mass percentage of the compound of Formula 1-1 was adjusted to 0.6 wt %, the transition metal content M in the graphite was adjusted to 0.05 wt %, the specific surface area of the graphite was adjusted to 2.7 g/cm³ and thus

$$\frac{B * \sqrt[3]{M}}{N * C 1} = 8.93 .$$

The electrolyte solutions, the negative electrode active materials, and the positive electrode active materials used in Examples 1 to 29 and Comparative Examples 1 to 5 were different. The specific compositions are illustrated in Table 1. In the equation, “x” and “*” are both used as multiplication signs, as is known in the art.

TABLE 1

| | Transition Metal Content in Negative Electrode Active Material (M, %) | Specific Surface Area of Negative Electrode Active Material (B, g/cm³) | Ratio of Total Mass of Electrolyte Solution to Discharge Capacity of Battery (N, g/Ah) | Compound Represented by Formula 1 | Addition Amount C1 (wt %) of Compound Represented by Formula 1 in Electrolyte Solution | Other Additives in Electrolyte Solution (wt %) | $Numerical Value Calculated by Equation \frac{B * \sqrt[3]{M}}{N * C 1}$ |
|---|---|---|---|---|---|---|---|
| Example 1 | 0.01 | 1.2 | 4 | Formulaa | 0.60 | / | 2.32 |
| | | | | 1-1 | | | |
| Example 2 | 0.01 | 1.2 | 4 | Formula | 0.60 | / | 2.32 |
| | | | | 1-2 | | | |
| Example 3 | 0.01 | 1.2 | 4 | Formula | 0.60 | / | 2.32 |
| | | | | 1-3 | | | |
| Example 4 | 0.01 | 1.2 | 4 | Formula | 0.60 | / | 2.32 |
| | | | | 1-4 | | | |
| Example 5 | 0.01 | 1.2 | 4 | Formula | 0.60 | / | 2.32 |
| | | | | 1-5 | | | |
| Example 6 | 0.01 | 1.2 | 4 | Formula | 0.60 | / | 2.32 |
| | | | | 1-6 | | | |
| Example 7 | 0.01 | 1.2 | 4 | Formula | 0.60 | / | 2.32 |
| | | | | 1-7 | | | |
| Example 8 | 0.01 | 1.2 | 4 | Formula | 0.60 | / | 2.32 |
| | | | | 1-8 | | | |
| Example 9 | 0.01 | 1.2 | 4 | Formula | 0.60 | / | 2.32 |
| | | | | 1-9 | | | |
| Example | 0.01 | 1.2 | 4 | Formula | 0.60 | / | 2.32 |
| 10 | | | | 1-10 | | | |
| Example | 0.005 | 1.2 | 4 | Formula | 0.60 | / | 1.84 |
| 11 | | | | 1-1 | | | |
| Example | 0.03 | 1.2 | 4 | Formula | 0.60 | / | 3.35 |
| 12 | | | | 1-1 | | | |
| Example | 0.01 | 0.7 | 4 | Formula | 0.60 | / | 1.35 |
| 13 | | | | 1-1 | | | |
| Example | 0.01 | 2.5 | 4 | Formula | 0.60 | / | 4.83 |
| 14 | | | | 1-1 | | | |
| Example | 0.01 | 1.2 | 4 | Formula | 0.30 | / | 4.64 |
| 15 | | | | 1-1 | | | |
| Example | 0.01 | 1.2 | 4 | Formula | 4.00 | / | 0.35 |
| 16 | | | | 1-1 | | | |
| Example | 0.01 | 2.7 | 4 | Formula | 0.60 | / | 5.22 |
| 17 | | | | 1-1 | | | |
| Example | 0.01 | 0.6 | 4 | Formula | 0.60 | / | 1.16 |
| 18 | | | | 1-1 | | | |
| Example | 0.01 | 1.2 | 5 | Formula | 0.60 | / | 1.86 |
| 19 | | | | 1-1 | | | |
| Example | 0.01 | 1.2 | 1.8 | Formula | 0.60 | / | 5.16 |
| 20 | | | | 1-1 | | | |
| Example | 0.05 | 1.2 | 4 | Formula | 0.60 | / | 3.97 |
| 21 | | | | 1-1 | | | |
| Example | 0.004 | 1.2 | 4 | Formula | 0.60 | / | 1.71 |
| 22 | | | | 1-1 | | | |
| Example | 0.01 | 1.2 | 4 | Formula | 4.50 | / | 0.31 |
| 23 | | | | 1-1 | | | |
| Example | 0.01 | 1.2 | 4 | Formula | 0.25 | / | 5.57 |
| 24 | | | | 1-1 | | | |
| Example | 0.01 | 1.2 | 2 | Formula | 0.60 | / | 4.64 |
| 25 | | | | 1-1 | | | |
| Example | 0.01 | 1.2 | 4.5 | Formula | 0.60 | / | 2.06 |
| 26 | | | | 1-1 | | | |
| Example | 0.01 | 1.2 | 4 | Formula | 0.60 | 1% PS | 2.32 |
| 27 | | | | 1-1 | | | |
| Example | 0.01 | 1.2 | 4 | Formula | 0.60 | / | 2.32 |
| 28 | | | | 1-1 | | | |
| Example | 0.01 | 1.2 | 4 | Formula | 0.60 | / | 2.32 |
| 29 | | | | 1-1 | | | |
| Comparative | 0.01 | 1.2 | 4 | / | / | / | / |
| Example 1 | | | | | | | |
| Comparative | 0.01 | 1.2 | 4 | / | / | / | / |
| Example 2 | | | | | | | |
| Comparative | 0.01 | 2.5 | 4 | Formula | 0.30 | / | 9.67 |
| Example 3 | | | | 1-1 | | | |
| Comparative | 0.005 | 1.2 | 4 | Formula | 4.00 | / | 0.28 |
| Example 4 | | | | 1-1 | | | |
| Comparative | 0.05 | 2.7 | 4 | Formula | 0.60 | / | 8.93 |
| Example 5 | | | | 1-1 | | | |

The batteries prepared in Examples 1 to 29 and Comparative Examples 1 to 5 were subjected to a high-temperature cycle test and a low-temperature discharge performance test, and specific test conditions were as follows.

High-temperature cycle test: the batteries were subjected to charge-discharge cycles at a current rate of 1.5C at 45° C. A maximum capacity among the first three cycles was recorded as Q. A capacity after 2000 cycles was recorded as Q2. A capacity retention rate (%) after high-temperature cycling was calculated according to the following equation: capacity retention rate (0%)=Q2/Q×100.

Low-temperature discharge performance test: the battery was subjected to charge-discharge cycle once at a current rate of 1C at room temperature, and a discharge capacity was recorded as Q3. Then, the battery was fully charged at a current rate of 1C, and subsequently put into a constant temperature box at −20° C. for 4 hours. The battery was discharged to a lower limit voltage at a current rate of 0.5C, and a discharge capacity was recorded as Q4. A low-temperature discharge capacity retention rate was calculated according to the following equation: low-temperature discharge capacity retention rate (0%)=Q4/Q3×100.

Results of the high-temperature cycle test and the low-temperature discharge performance test of the batteries prepared in Examples 1 to 29 and Comparative Examples 1 to 5 are shown in Table 2.

TABLE 2

| | High Temperature Cycle | Low Temperature Discharge |
|---|---|---|
| | Retention Rate/% | Retention Rate/% |
| Example 1 | 83.80 | 63.10 |
| Example 2 | 82.10 | 62.80 |
| Example 3 | 83.10 | 63.60 |
| Example 4 | 83.40 | 63.40 |
| Example 5 | 82.90 | 62.30 |
| Example 6 | 83.80 | 62.60 |
| Example 7 | 82.70 | 63.50 |
| Example 8 | 83.30 | 63.20 |
| Example 9 | 82.50 | 62.20 |
| Example 10 | 82.60 | 62.90 |
| Example 11 | 84.10 | 60.20 |
| Example 12 | 81.20 | 64.20 |
| Example 13 | 84.20 | 60.80 |
| Example 14 | 80.90 | 64.70 |
| Example 15 | 83.30 | 62.10 |
| Example 16 | 83.80 | 63.30 |
| Example 17 | 70.20 | 52.70 |
| Example 18 | 71.60 | 50.90 |
| Example 19 | 76.10 | 54.10 |
| Example 20 | 70.80 | 55.60 |
| Example 21 | 69.70 | 51.60 |
| Example 22 | 71.90 | 50.20 |
| Example 23 | 70.50 | 52.20 |
| Example 24 | 69.80 | 53.30 |
| Example 25 | 80.40 | 63.30 |
| Example 26 | 84.80 | 62.50 |
| Example 27 | 84.90 | 63.00 |
| Example 28 | 79.20 | 68.30 |
| Example 29 | 78.3 | 68.8 |
| Comparative Example 1 | 25.4 | 40.1 |
| Comparative Example 2 | 30.1 | 40.9 |
| Comparative Example 3 | 61.40 | 50.70 |
| Comparative Example 4 | 65.50 | 50.10 |
| Comparative Example 5 | 30.8 | 41.6 |

From the data in Table 2, it can be seen that both the high-temperature cycle retention rate and the low-temperature discharge retention rate of the batteries according to Examples 1 to 29 are significantly higher than those of the batteries in Comparative Examples 1 to 2, which do not contain the compound represented by Formula 1. In particular, although the compound represented by Formula 1 is added in Comparative Example 3 and Comparative Example 4, the calculated value based on the equation

$$\frac{B * \sqrt[3]{M}}{N * C 1}$$

does not fall within a range of 0.3 to 5.6. As a result, the high-temperature cycle retention rate and low-temperature discharge retention rate of these batteries are still much lower compared to those of Examples 1 to 29. This indicates that to achieve excellent low-temperature discharge performance and cycling stability of the finally obtained battery, not only should the compound represented by Formula 1 be added to the electrolyte solution in the present disclosure, but the calculated value of the equation

$$\frac{B * \sqrt[3]{M}}{N * C 1}$$

needs to fall within the range of 0.3 to 5.6.

It should be understood that the present disclosure is not limited to the embodiments described above. The above embodiments are merely illustrative. Any embodiments that have configurations substantially identical to the technical concept of the present disclosure and achieve the same functions and effects are included within the technical scope of the present disclosure. In addition, other embodiments obtained by applying various modifications conceivable to those skilled in the art to the embodiments of the present disclosure and by combining some constituent elements of the embodiments of the present disclosure are also included in the scope of the present disclosure without departing from the spirit of the present disclosure.

What is claimed is:

1. A battery, comprising:
a positive electrode plate,
a negative electrode plate, and
an electrolyte solution,
wherein the electrolyte solution comprises a compound represented by Formula 1, 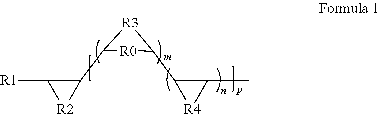
where m is an integer ranging from 0 to 3; n is an integer ranging from 0 to 3; m and n are not 0 simultaneously; p is an integer ranging from 1 to 5; R₀ is single bond or methylene;
R₁ is hydrogen, halogen, hydrocarbyl with 1 to 5 carbon atoms or halogenated hydrocarbyl with 1 to 5 carbon atoms; and R₂, R₃, and R₄ are each independently 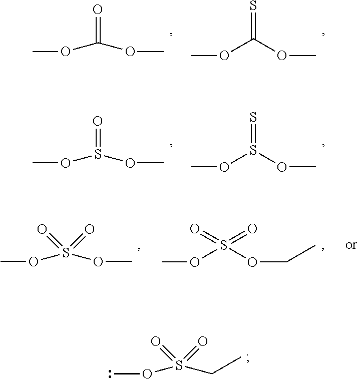
wherein a mass percentage of a transition metal in a negative electrode active material of the negative electrode plate is M; a specific surface area of the negative electrode active material is B m²/g; a ratio of a total mass of the electrolyte solution to a discharge capacity of the battery is N g/Ah; and a mass percentage of the compound represented by Formula 1 in the electrolyte solution is C1, wherein the following formula is satisfied:
$$0.3 \leq \frac{B * \sqrt[3]{M}}{N * C 1} \leq 5.6 .$$

2. The battery according to claim 1, wherein R₁ is hydrogen, halogen, methyl, ethyl, n-propyl, isopropyl, butyl, pentyl, hexyl, halogenated methyl, halogenated ethyl, halogenated n-propyl, halogenated isopropyl, halogenated butyl, halogenated pentyl, or halogenated hexyl.

3. The battery according to claim 1, wherein the compound represented by Formula 1 comprises at least one of the following compounds:

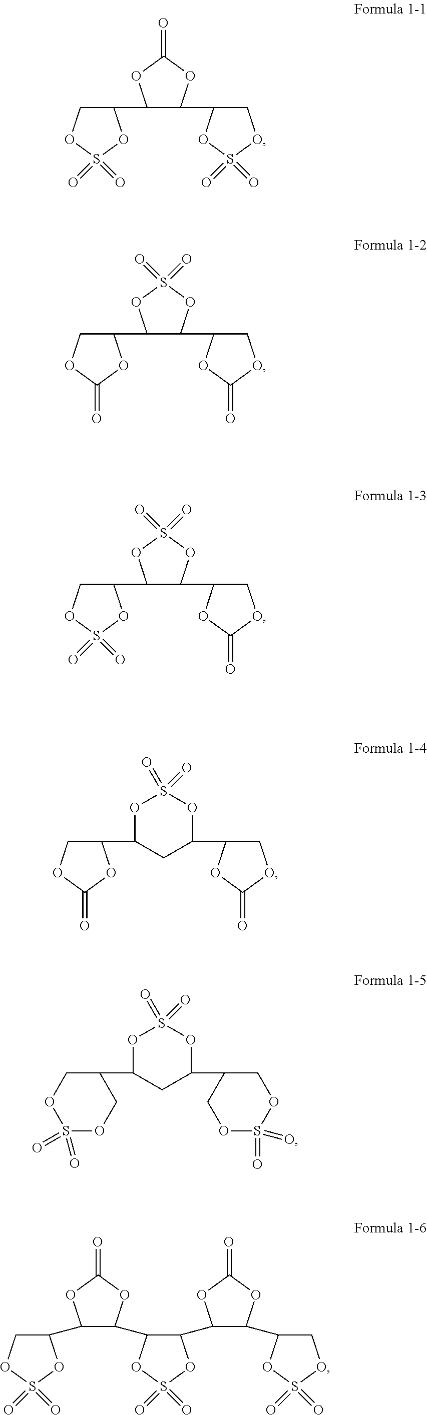 [SMILES: O=C1OC(C2COS(=O)(=O)O2)C(C2COS(=O)(=O)O2)O1 ; O=C1OCC(C2OS(=O)(=O)OC2C2COC(=O)O2)O1 ; O=C1OCC(C2OS(=O)(=O)OC2C2COS(=O)(=O)O2)O1 ; O=C1OCC(C2CC(C3COC(=O)O3)OS(=O)(=O)O2)O1 ; O=S1(=O)OCC(C2CC(C3COS(=O)(=O)OC3)OS(=O)(=O)O2)CO1 ; O=C1OC(C2COS(=O)(=O)O2)C(C2OS(=O)(=O)OC2C2OC(=O)OC2C2COS(=O)(=O)O2)O1]

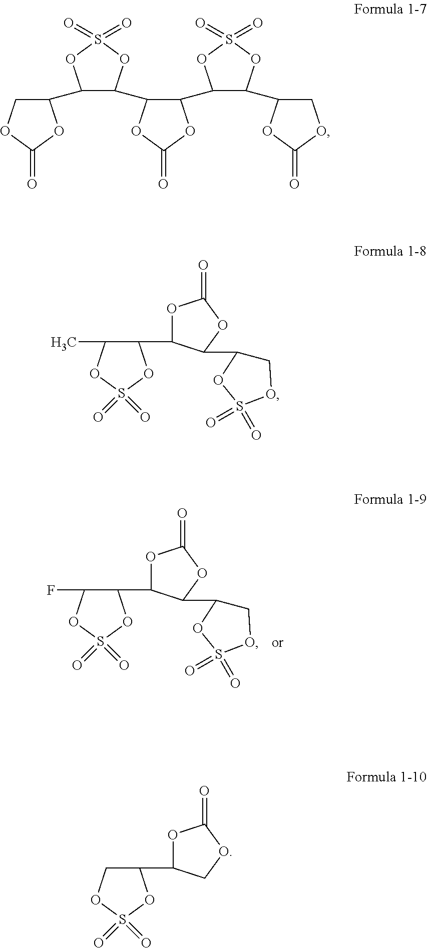 [SMILES: O=C1OCC(C2OS(=O)(=O)OC2C2OC(=O)OC2C2OS(=O)(=O)OC2C2COC(=O)O2)O1 ; CC1OS(=O)(=O)OC1C1OC(=O)OC1C1COS(=O)(=O)O1 ; O=C1OC(C2COS(=O)(=O)O2)C(C2OS(=O)(=O)OC2F)O1 ; O=C1OCC(C2COS(=O)(=O)O2)O1]

4. The battery according to claim 3, wherein 0.005%≤M≤0.03%.

5. The battery according to claim 3, wherein 0.3%≤C1≤4%.

6. The battery according to claim 4, wherein 0.3%≤C1≤4%.

7. The battery according to claim 3, wherein the transition metal comprises at least one of iron, copper, nickel, or zinc.

8. The battery according to claim 3, wherein 0.7≤B≤2.5.

9. The battery according to claim 4, wherein 0.7≤B≤2.5.

10. The battery according to claim 5, wherein 0.7≤B≤2.5.

11. The battery according to claim 6, wherein 0.7≤B≤2.5.

12. The battery according to claim 3, wherein 2≤N≤4.5.

13. The battery according to claim 4, wherein 2≤N≤4.5.

14. The battery according to claim 8, wherein 2≤N≤4.5.

15. The battery according to claim 9, wherein 2≤N≤4.5.

16. The battery according to claim 3, wherein the negative electrode active material of the negative electrode plate comprises a graphite or a silicon-based material.

17. The battery according to claim 3, wherein the electrolyte solution further comprises an electrolyte salt, the electrolyte salt comprising a lithium salt or a sodium salt.

18. The battery according to claim 17, wherein, based on a total mass of the electrolyte solution, a mass percentage of the electrolyte salt ranges from 10% to 20%.

19. The battery according to claim 3, wherein the battery satisfies one of the following (a) and (b):
(a) the battery is a lithium battery, and a positive electrode active material of the positive electrode plate comprises a lithium iron phosphate material, a nickel-cobalt-manganese ternary material, a lithium cobalt oxide material, a lithium manganese iron phosphate material, a lithium manganese oxide material or a lithium nickel manganese oxide material; and
(b) the battery is a sodium battery, and a positive electrode active material of the positive electrode plate comprises a sodium iron phosphate material or a three-dimensional tunnel-type Na_{0.44}MnO₂.
